(19) United States
(12) Patent Application Publication
(10) Pub. No.: US 2020/0050210 A1
(43) Pub. Date: Feb. 13, 2020

(54) AUTOPILOT CONTROL SYSTEM AND METHOD

(71) Applicant: HON HAI PRECISION INDUSTRY CO., LTD., New Taipei (TW)

(72) Inventor: JUNG-YI LIN, New Taipei (TW)

(21) Appl. No.: 16/194,221

(22) Filed: Nov. 16, 2018

(30) Foreign Application Priority Data
Aug. 13, 2018 (CN) 201810917912.3

(51) Int. Cl. G05D 1/02; G08G 1/16; H04W 4/46

(52) U.S. Cl. CPC G05D 1/0223; G05D 1/0257; H04W 4/46; G05D 1/0236; G08G 1/163; G05D 1/0255

(57) ABSTRACT

An autopilot control method is implemented in an electronic device of a host vehicle. The autopilot control method includes obtaining a first distance between the host vehicle and a first vehicle in front of the host vehicle, obtaining a second distance between the host vehicle and a second vehicle in front of the host vehicle, and controlling operation of the host vehicle according to the first distance and the second distance.

### FIELD

The subject matter herein generally relates to autopilot systems, and more particularly to an autopilot control system for controlling operation of a vehicle.

### BACKGROUND

Generally, autopilot systems of vehicles are designed for maintaining a predetermined distance from a first vehicle in front of a host vehicle of the autopilot system. However, the autopilot system may not be able to anticipate whether the first vehicle in front of the host vehicle will suddenly brake. Improvement in the art is preferred.

### BRIEF DESCRIPTION OF THE DRAWINGS

Embodiments of the present disclosure will now be described, with reference to the attached figures.

FIG. 1 is a block diagram of an electronic device including an autopilot system in accordance with an embodiment of the present disclosure.

FIG. 2 is a block diagram of function modules of the autopilot system in FIG. 1.

FIG. 3 is a diagram indicating a first distance between a host vehicle and a first vehicle and a second distance between the host vehicle and a second vehicle.

FIG. 4 is a diagram indicating the first distance is increasing and the second distance remaining constant.

FIG. 5 is a diagram indicating the first distance is decreasing and the second distance remaining constant.

FIG. 6 is a diagram indicating the first distance remaining constant and the second distance is increasing.

FIG. 7 is a diagram indicating the first distance is increasing and the second distance is increasing.

FIG. 8 is a diagram indicating the first distance is decreasing and the second distance is increasing.

FIG. 9 is a diagram indicating the first distance remaining constant and the second distance is decreasing.

FIG. 10 is a diagram indicating the first distance is decreasing and the second distance is decreasing.

FIG. 11 is a flowchart diagram of an embodiment of an autopilot control method.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

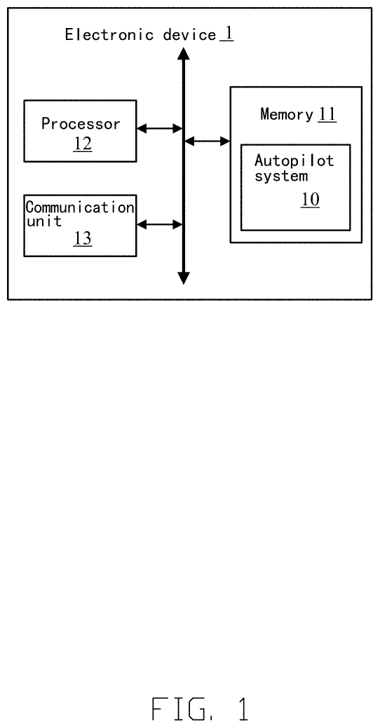

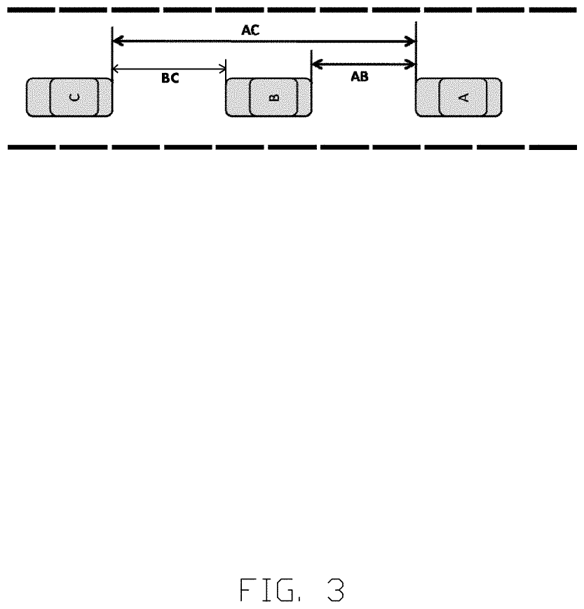

FIG. 1 shows an embodiment of an autopilot system 10 implemented in an electronic device 1. The electronic device 1 may includes, but is not limited to, a memory 11 and at least one processor 12. The processor 12 executes functions of the autopilot system 10 and of the electronic device 1. The electronic device 1 is mounted in a host vehicle A (shown in FIG. 3)

The electronic device 1 may be, but is not limited to, a car-mounted terminal, a smart mobile phone, a tablet computer, a desktop computer, an all-in-one computer, or the like. The electronic device 1 may further include other components not shown in FIG. 1, such as a circuit system, an input/output port, a battery, an operating system, and the like.

In one embodiment, the processor 12 can be a central processing unit, a microprocessing unit, or other data processing chip. The memory 11 can be an external device, a smart media card, a secure digital card, or a flash card, for example. In at least one embodiment, the memory 11 can be a read-only memory, a random access memory, a programmable read-only memory, an erasable programmable read-only memory, a one-time programmable read-only memory, an electrically-erasable programmable read-only memory, a compact disk read-only memory, or an external storage device such as a magnetic disk, a hard disk, a smart media card, a secure digital card, a flash card, or the like.

The memory 11 can store the autopilot system 10, and the autopilot system 10 can be executed by the processor 12. In another embodiment, the autopilot system 10 can be embedded in the processor 12. The autopilot system 10 can be divided into a plurality of modules, which can include one or more software programs in the form of computerized codes stored in the memory 11. The computerized codes can include instructions executed by the processor 12 to provide functions for the modules.

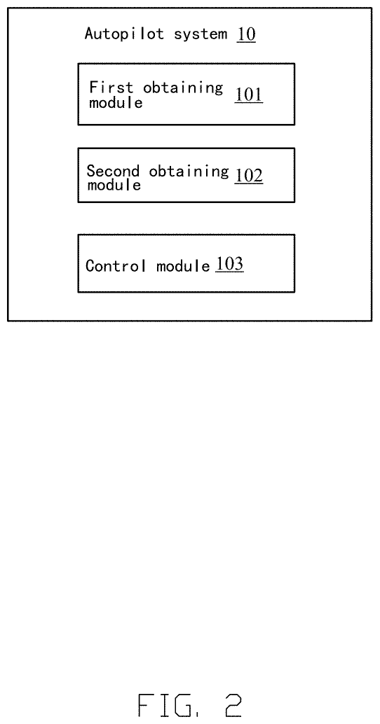

As shown in FIG. 2, the autopilot system 10 includes a first obtaining module 101, a second obtaining module 102, and a control module 103.

Referring to FIG. 3, the autopilot system 10 can control operation of the host vehicle A according to a first distance AB and a second distance AC. The first distance AB is a distance between the host vehicle A and a first vehicle B in front of the host vehicle A. The second distance AC is a distance between the host vehicle A and a second vehicle C in front of the host vehicle A. The second vehicle C is in front of the first vehicle B. The autopilot system 10 controls the operation of the host vehicle A to maintain a safe driving distance between the host vehicle A and the first vehicle B.

The first obtaining module 101 obtains a current speed of the host vehicle A and the first distance AB.

In one embodiment, the current speed is obtained by a speed sensor of the host vehicle. The speed sensor may include a magnetoelectric sensor, a Hall sensor, and a photoelectric sensor.

In one embodiment, the current speed is obtained by a roadside unit or a car-mounted unit monitoring a travel distance of the host vehicle A within a predetermined time duration.

In one embodiment, the first distance between the host vehicle A and the first vehicle B is obtained by an ultrasound sensor, a radar sensor, a laser sensor, or other distance sensor. The distance sensor is mounted in the host vehicle A and transmits a signal around a vicinity of the host vehicle A. The signal may be an ultrasound signal, an electromagnetic signal, a laser pulse, or other reflective signal of a distance sensor. The signal is reflected by the first vehicle B and received by the distance sensor. A time difference between transmitting the signal and receiving the reflected signal is calculated, and the first distance is calculated according to the time difference and the current speed.

In one embodiment, the first distance is obtained by an image processing system of the host vehicle A. The image processing system obtains an image of the first vehicle B, and the first distance is calculated according to principle analysis processing of the obtained image. The image processing system may include at least one of an infrared thermal imaging sensor, an imaging sensor, and an optical scanning mirror.

The second obtaining module 102 obtains the second distance AC between the host vehicle A and the second vehicle C.

In one embodiment (not shown in figures), the second distance AC is obtained by the distance sensor or the image processing system as described above. It should be understood that in order to utilize the distance sensor or the image processing system, the host vehicle A must be to the left or to the right behind the first vehicle B in order for the transmitted signal to be reflected by the second vehicle C or for the image processing system to obtain the image of the second vehicle C.

In one embodiment, the second distance AC is obtained by a vehicle-to-vehicle networking system utilizing a communication unit 13 (shown in FIG. 1) of the electronic device 1 and a communication unit of the first vehicle B to establish communication between the host vehicle A and the first vehicle B. In one embodiment, the communication unit 13 is a ZigBee communication unit to transmit distance information of the host vehicle A or to receive distance information of other vehicles. The communication unit 13 of the host vehicle A receives the distance information from the first vehicle B to obtain a distance BC between the first vehicle B and the second vehicle C. Thus, the second distance AC is obtained by adding the first distance AB and the distance BC.

The control module 103 controls the operation of the host vehicle A according to the first distance AB and the second distance AC.

In one embodiment, when the first distance AB and the second distance AC do not change, the control module 103 controls the host vehicle A to maintain the current speed.

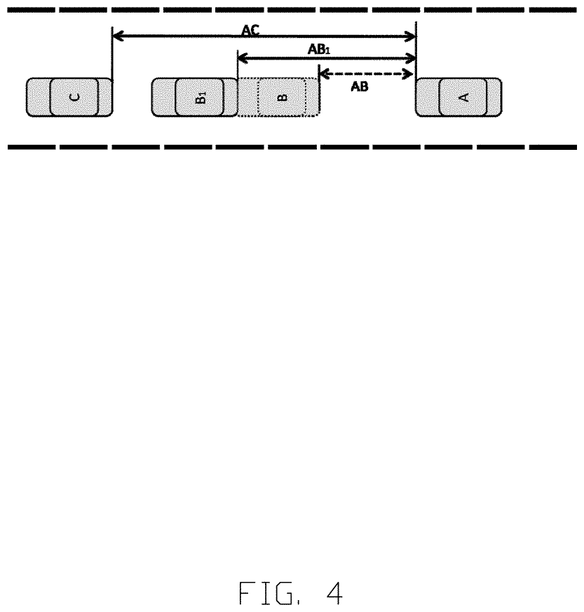

In one embodiment, when the second distance AC does not change, the first distance AB increases, and the first distance AB is less than the second distance AC, the control module 103 controls the host vehicle A to maintain the current speed. As shown in FIG. 4, the first distance AB increases to AB₁. The distance AB₁ is less than the second distance AC, so the control module 103 controls the host vehicle A to maintain the current speed.

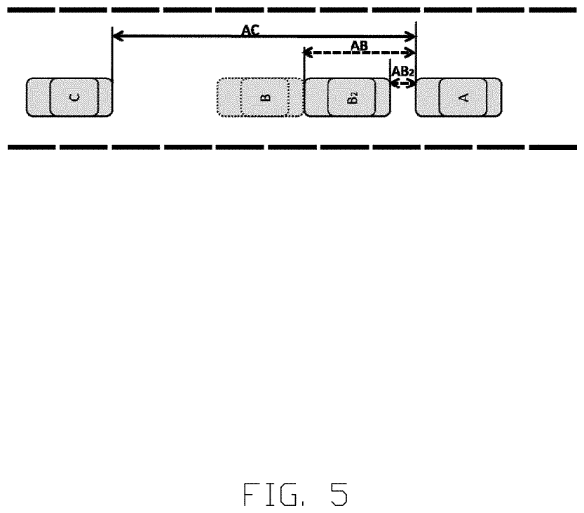

In one embodiment, when the second distance AC does not change and the first distance AB decreases, the control module 103 controls the host vehicle A to reduce the current speed. As shown in FIG. 5, the first distance AB decreases to AB₂. The control module 103 controls the host vehicle A to reduce the current speed.

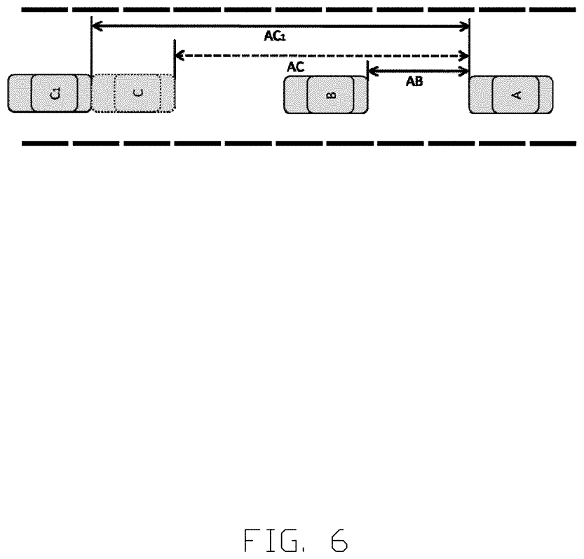

In one embodiment, when the first distance AB does not change and the second distance AC increases, the control module 103 controls the host vehicle A to maintain the current speed. As shown in FIG. 6, the second distance AC increases to AC₁. The control module 103 controls the host vehicle A to maintain the current speed. The control module 103 also notifies a driver of the host vehicle A that it is safe to pass the first vehicle B.

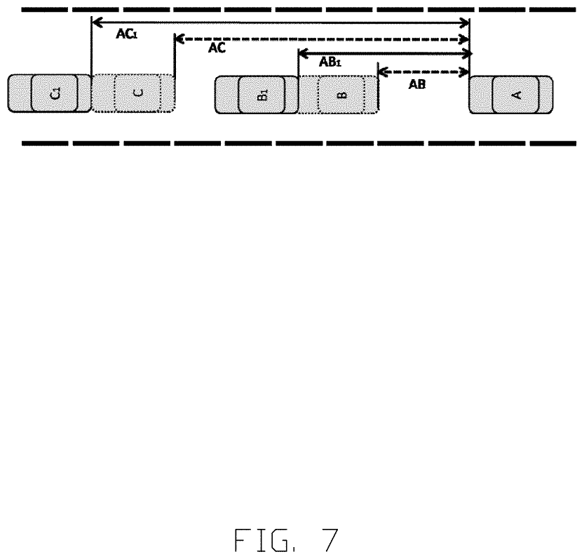

In one embodiment, when the second distance AC increases and the first distance AB increases, the control module 103 controls the host vehicle A to increase the current speed. As shown in FIG. 7, the first distance AB increases to AB₁, and the second distance AC increases to AC₁. The control module 103 controls the host vehicle A to increase the current speed. The control module 103 also determines whether the current speed is greater than a predetermined speed. When the current speed is greater than the predetermined speed, the control module 103 controls the host vehicle A to reduce the current speed. The predetermined speed may be a speed limit of a road.

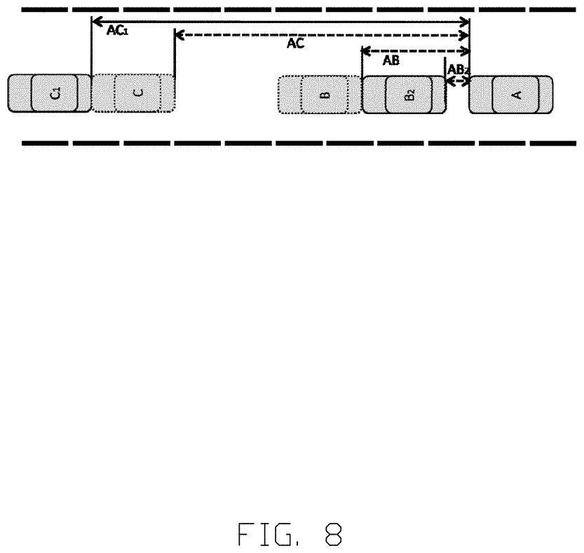

In one embodiment, when the second distance AC increases and the first distance AB decreases, the control module 103 controls the host vehicle A to reduce the current speed. As shown in FIG. 8, the second distance AC increases to AC₁, and the first speed AB decreases to AB₂. The control module 103 controls the host vehicle A to reduce the current speed.

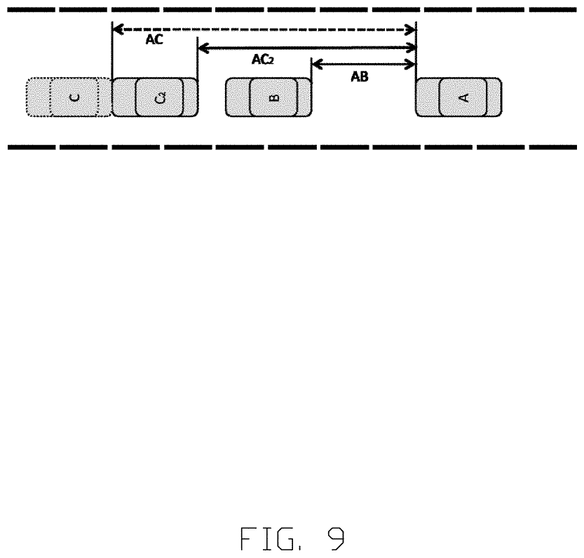

In one embodiment, when the second distance AC decreases and the first distance AB does not change, the control module 103 controls the host vehicle A to reduce the current speed. As shown in FIG. 9, the second distance AC decreases to AC₂. The control module 103 controls the host vehicle A to reduce the current speed.

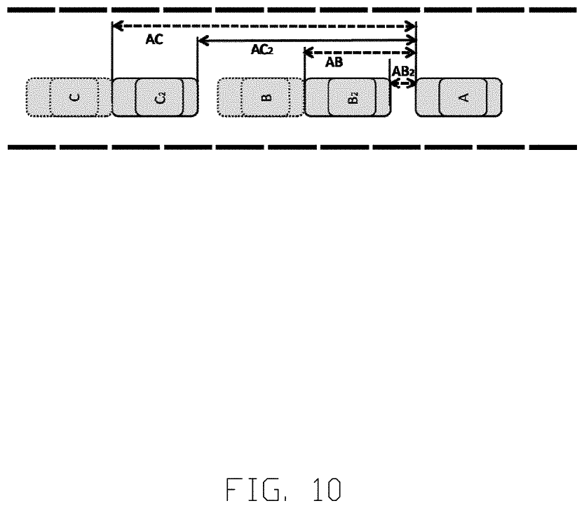

In one embodiment, when the second distance AC decreases and the first distance AB decreases, the control module 103 controls the host vehicle A to reduce the current speed. As shown in FIG. 10, the first distance AB decreases to AB₂, and the second distance AC decreases to AC₂. The control module 103 controls the host vehicle A to reduce the current speed.

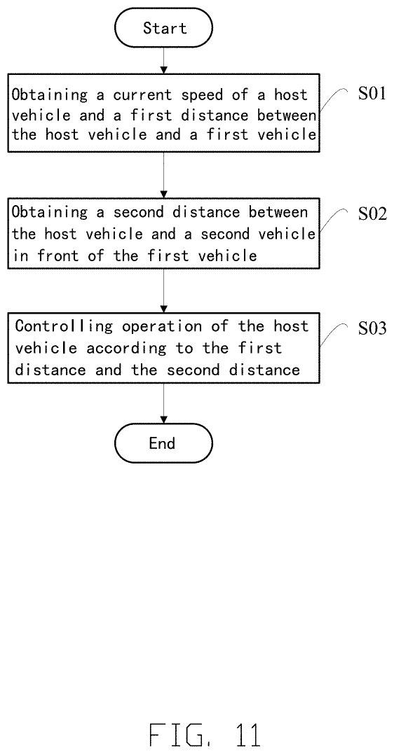

FIG. 11 shows a flowchart of an embodiment of an autopilot control method. The embodiment of method is provided by way of example, as there are a variety of ways to carry out the method. The method described below can be carried out using the configurations illustrated in FIGS. 1-10, and various elements of these figures are referenced in explaining the method. Each block shown in FIG. 11 represents one or more processes, methods, or subroutines carried out in the method. Furthermore, the illustrated order of blocks is by example only, and the order of the blocks can be changed. Additional blocks can be added or fewer blocks can be utilized, without departing from this disclosure. The embodiment can begin at block S01.

At block S01, the first obtaining module 101 obtains the current speed of the host vehicle A and the first distance AB between the host vehicle A and the first vehicle B.

In one embodiment, the current speed is obtained by a speed sensor of the host vehicle. The speed sensor may include a magnetoelectric sensor, a Hall sensor, and a photoelectric sensor.

In one embodiment, the current speed is obtained by a roadside unit or a car-mounted unit monitoring a travel distance of the host vehicle A within a predetermined time duration.

In one embodiment, the first distance AB between the host vehicle A and the first vehicle B by an ultrasound sensor, a radar sensor, a laser sensor, or other distance sensor. The distance sensor is mounted in the host vehicle A and transmits a signal around a vicinity of the host vehicle A. The signal may be an ultrasound signal, an electromagnetic signal, a laser pulse, or other reflective signal of a distance sensor. The signal is reflected by the first vehicle B and received by the distance sensor. A time difference between transmitting the signal and receiving the reflected signal is calculated, and the first distance is calculated according to the time difference and the current speed.

In one embodiment, the first distance AB is obtained by an image processing system of the host vehicle A. The image processing system obtains an image of the first vehicle B, and the first distance AB is calculated according to principle analysis processing of the obtained image. The image processing system may include at least one of an infrared thermal imaging sensor, an imaging sensor, and an optical scanning mirror.

At block S02, the second obtaining module 102 obtains the second distance AC between the host vehicle A and the second vehicle C.

In one embodiment (not shown in figures), the second distance AC is obtained by the distance sensor or the image processing system as described above. It should be understood that in order to utilize the distance sensor or the image processing system, the host vehicle A must be to the left or to the right behind the first vehicle B in order for the transmitted signal to be reflected by the second vehicle C or for the image processing system to obtain the image of the second vehicle C.

In one embodiment, the second distance AC is obtained by a vehicle-to-vehicle networking system utilizing a communication unit 13 (shown in FIG. 1) of the electronic device 1 and a communication unit of the first vehicle B to establish communication between the host vehicle A and the first vehicle B. In one embodiment, the communication unit 13 is a ZigBee communication unit to transmit distance information of the host vehicle or to receive distance information of other vehicles. The communication unit 13 of the host vehicle A receives the distance information from the first vehicle B to obtain a distance BC between the first vehicle B and the second vehicle C. Thus, the second distance AC is obtained by adding the first distance AB and the distance BC.

At block S03, the control module 103 controls operations of the host vehicle A according to the first distance AB and the second distance AC.

In one embodiment, when the first distance AB and the second distance AC do not change, the control module 103 controls the host vehicle A to maintain the current speed.

In one embodiment, when the second distance AC does not change, the first distance AB increases, and the first distance AB is less than the second distance AC, the control module 103 controls the host vehicle A to maintain the current speed. As shown in FIG. 4, the first distance AB increases to AB₁. The distance AB₁ is less than the second distance AC, so the control module 103 controls the host vehicle A to maintain the current speed.

In one embodiment, when the second distance AC does not change and the first distance AB decreases, the control module 103 controls the host vehicle A to reduce the current speed. As shown in FIG. 5, the first distance AB decreases to AB₂. The control module 103 controls the host vehicle A to reduce the current speed.

In one embodiment, when the first distance AB does not change and the second distance AC increases, the control module 103 controls the host vehicle A to maintain the current speed. As shown in FIG. 6, the second distance AC increases to AC₁. The control module 103 controls the host vehicle A to maintain the current speed. The control module 103 also notifies a driver of the host vehicle A that it is safe to pass the first car B.

In one embodiment, when the second distance AC increases and the first distance AB increases, the control module 103 controls the host vehicle A to increase the current speed. As shown in FIG. 7, the first distance AB increases to AB₁, and the second distance AC increases to AC₁. The control module 103 controls the host vehicle A to increase the current speed. The control module 103 also determines whether the current speed is greater than a predetermined speed. When the current speed is greater than the predetermined speed, the control module 103 controls the host vehicle A to reduce the current speed. The predetermined speed may be a speed limit of a road.

In one embodiment, when the second distance AC increases and the first distance AB decreases, the control module 103 controls the host vehicle A to reduce the current speed. As shown in FIG. 8, the second distance AC increases to AC₁, and the first speed AB decreases to AB₂. The control module 103 controls the host vehicle A to reduce the current speed.

In one embodiment, when the second distance AC decreases and the first distance AB does not change, the control module 103 controls the host vehicle A to reduce the current speed. As shown in FIG. 9, the second distance AC decreases to AC₂. The control module 103 controls the host vehicle A to reduce the current speed.

In one embodiment, when the second distance AC decreases and the first distance AB decreases, the control module 103 controls the host vehicle A to reduce the current speed. As shown in FIG. 10, the first distance AB decreases to AB₂, and the second distance AC decreases to AC₂. The control module 103 controls the host vehicle A to reduce the current speed.

The autopilot control method as described above maintains a safe distance between the host vehicle A and the first vehicle B by controlling operation of the host vehicle A according to the first distance AB and the second distance AC.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An autopilot control method implemented in an electronic device of a host vehicle, the autopilot control method comprising:
obtaining a first distance between the host vehicle and a first vehicle in front of the host vehicle;
obtaining a second distance between the host vehicle and a second vehicle in front of the host vehicle; and
controlling operations of the host vehicle according to the first distance and the second distance.

2. The autopilot control method of claim 1, further comprising obtaining a current speed of the host vehicle.

3. The autopilot control method of claim 2, wherein controlling the operations of the host vehicle comprises:
controlling the host vehicle to maintain the current speed of the host vehicle when the first distance and the second distance do not change;
controlling the host vehicle to maintain the current speed of the host vehicle when the second distance does not change, the first distance increases, and the first distance is less than the second distance;
controlling the host vehicle to reduce the current speed when the second distance does not change and the first distance decreases;
controlling the host vehicle to maintain the current speed when the first distance does not change and the second distance increases;
controlling the host vehicle to increase the current speed when the second distance increases and the first distance increases;
controlling the host vehicle to reduce the current speed when the second distance increases and the first distance decreases;
controlling the host vehicle to reduce the current speed when the second distance decreases and the first distance does not change; and
controlling the host vehicle to reduce the current speed when the second distance decreases and the first distance decreases.

4. The autopilot control method of claim 2, wherein the first distance is obtained by:
transmitting, by a distance sensor of the host vehicle, a signal around a vicinity of the host vehicle;
receiving a reflected signal from the first vehicle in front of the host vehicle;
calculating a time difference between transmitting the signal and receiving the reflected signal; and
calculating the first distance according to the time difference and the current speed.

5. The autopilot control method of claim 4, wherein the distance sensor comprises at least one of an ultrasound sensor, a radar sensor, and a laser sensor.

6. The autopilot control method of claim 1, wherein the first distance is obtained by:
obtaining, by an image processing system of the host vehicle, an image of the first vehicle; and
calculating the first distance by principle analysis processing of the image of the first vehicle.

7. The autopilot control method of claim 6, wherein the image processing system comprises at least one of an infrared thermal imaging sensor, an imaging sensor, and an optical scanning mirror.

8. The autopilot control method of claim 1, wherein the second distance is obtained by:
obtaining, from a communication unit of the host vehicle in communication with the first vehicle, a distance between the first vehicle and the second vehicle; and
calculating the second distance by adding the first distance and the distance between the first vehicle and the second vehicle.

9. An electronic device comprising:
a processor; and
a memory storing a plurality of instructions which, when executed by the processor, cause the processor to:
obtain a first distance between a host vehicle of the electronic device and a first vehicle in front of the host vehicle;
obtain a second distance between the host vehicle and a second vehicle in front of the host vehicle; and
control operations of the host vehicle according to the first distance and the second distance.

10. The electronic device of claim 9, wherein the processor obtains a current speed of the host vehicle.

11. The electronic device of claim 10, wherein controlling the operations of the host vehicle comprises:
controlling the host vehicle to maintain the current speed of the host vehicle when the first distance and the second distance do not change;
controlling the host vehicle to maintain the current speed of the host vehicle when the second distance does not change, the first distance increases, and the first distance is less than the second distance;
controlling the host vehicle to reduce the current speed when the second distance does not change and the first distance decreases;
controlling the host vehicle to maintain the current speed when the first distance does not change and the second distance increases;
controlling the host vehicle to increase the current speed when the second distance increases and the first distance increases;
controlling the host vehicle to reduce the current speed when the second distance increases and the first distance decreases;
controlling the host vehicle to reduce the current speed when the second distance decreases and the first distance does not change; and
controlling the host vehicle to reduce the current speed when the second distance decreases and the first distance decreases.

12. The electronic device of claim 10, wherein the first distance is obtained by:
transmitting, by a distance sensor of the host vehicle a signal around a vicinity of the host vehicle;
receiving a reflected signal from the first vehicle in front of the host vehicle;
calculating a time difference between transmitting the signal and receiving the reflected signal; and
calculating the first distance according to the time difference and the current speed.

13. The electronic device of claim 9, wherein the first distance is obtained by:
obtaining, by an image processing system of the host vehicle, an image of the first vehicle; and
calculating the first distance by principle analysis processing of the image of the first vehicle.

14. The electronic device of claim 9, wherein the second distance is obtained by:
obtaining, from a communication unit of the host vehicle in communication with the first vehicle, a distance between the first vehicle and the second vehicle; and
calculating the second distance by adding the first distance and the distance between the first vehicle and the second vehicle.

15. A non-transitory storage medium having stored thereon instructions that, when executed by at least one processor of an electronic device of a host vehicle, causes the at least one processor to execute instructions of an autopilot control method comprising:
obtaining a first distance between the host vehicle and a first vehicle in front of the host vehicle;
obtaining a second distance between the host vehicle and a second vehicle in front of the host vehicle; and
controlling operations of the host vehicle according to the first distance and the second distance.

16. The non-transitory storage medium of claim 15, wherein the method further comprises:
obtaining a current speed of the host vehicle.

17. The non-transitory storage medium of claim 16, wherein controlling of the operations comprises:
controlling the host vehicle to maintain the current speed of the host vehicle when the first distance and the second distance do not change;
controlling the host vehicle to maintain the current speed of the host vehicle when the second distance does not change, the first distance increases, and the first distance is less than the second distance;
controlling the host vehicle to reduce the current speed when the second distance does not change and the first distance decreases;
controlling the host vehicle to maintain the current speed when the first distance does not change and the second distance increases;
controlling the host vehicle to increase the current speed when the second distance increases and the first distance increases;
controlling the host vehicle to reduce the current speed when the second distance increases and the first distance decreases;
controlling the host vehicle to reduce the current speed when the second distance decreases and the first distance does not change; and
controlling the host vehicle to reduce the current speed when the second distance decreases and the first distance decreases.

18. The non-transitory storage medium of claim 16, wherein the first distance is obtained by:
transmitting, by a distance sensor of the host vehicle, a signal around a vicinity of the host vehicle;
receiving a reflected signal from the first vehicle in front of the host vehicle;
calculating a time difference between transmitting the signal and receiving the reflected signal; and
calculating the first distance according to the time difference and the current speed.

19. The non-transitory storage medium of claim 15, wherein the first distance is obtained by:
obtaining, by an image processing system of the host vehicle, an image of the first vehicle; and
calculating the first distance by principle analysis processing of the image of the first vehicle.

20. The non-transitory storage medium of claim 15, wherein the second distance is obtained by:
obtaining, from a communication unit of the host vehicle in communication with the first vehicle, a distance between the first vehicle and the second vehicle; and
calculating the second distance by adding the first distance and the distance between the first vehicle and the second vehicle.
